(19) United States
(12) Patent Application Publication
(10) Pub. No.: US 2012/0089392 A1
(43) Pub. Date: Apr. 12, 2012

(54) SPEECH RECOGNITION USER INTERFACE

(75) Inventors: Vanessa Larco, Kirkland, WA (US); Ali M. Vassigh, Redmond, WA (US); Alan T. Shen, Redmond, WA (US); Christian Klein, Duvall, WA (US); Thomas M. Soemo, Redmond, WA (US)

(73) Assignee: MICROSOFT CORPORATION, Redmond, WA (US)

(21) Appl. No.: 12/900,004

(22) Filed: Oct. 7, 2010

(51) Int. Cl. G10L 15/00; G10L 21/00

(52) U.S. Cl. 704/231; 704/275; 704/E15.001; 704/E21.001

(57) ABSTRACT

Speech recognition techniques are disclosed herein. In one embodiment, a novice mode is available such that when the user is unfamiliar with the speech recognition system, a voice user interface (VUI) may be provided to guide them. The VUI may display one or more speech commands that are presently available. The VUI may also provide feedback to train the user. After the user becomes more familiar with speech recognition, the user may enter speech commands without the aid of the novice mode. In this “experienced mode,” the VUI need not be displayed. Therefore, the user interface is not cluttered.

### CROSS-REFERENCE TO RELATED APPLICATION

The following application is cross-referenced and incorporated by reference herein in its entirety:

U.S. patent application Ser. No. 12/818,898, entitled “Compound Gesture-Speech command,” by Klein et al., filed on Jun. 18, 2010.

### BACKGROUND

Users of computer games and other multimedia applications are typically provided with user controls which allow the users to accomplish basic functions, such as browse and select content, as well as perform more sophisticated functions, such as manipulate game characters. Typically, these controls are provided as inputs to a controller through an input device, such as a mouse, keyboard, microphone, image source, audio source, remote controller, or the like. Unfortunately, learning and using such controls can be difficult or cumbersome, thus creating a barrier between a user and full enjoyment of such games, applications and their features.

### SUMMARY

Systems and methods for using speech commands to control an electronic device are disclosed. There may be a novice mode in which a user interface is presented to provide speech recognition training to the user. There may also be an experienced mode in which the user interface is not displayed. Switching between the novice mode and experienced mode may be effortless and transparent to the user. Therefore, the user may benefit from the novice mode when needed, but the display need not be cluttered with the training user interface when not needed.

One embodiment includes a method of controlling an electronic device. Voice input is received that indicates speech recognition is requested. A determination is made of whether the voice input is for a first mode or a second mode of speech recognition. A voice user interface is displayed on a display screen of the electronic device in response to determining that the voice input is for the first mode. The voice user interface shows one or more speech commands that are currently available. Training feedback is provided through the voice user interface when in the first mode. The electronic device is controlled based on a command in the voice input in response to determining that the voice input is for the second mode.

One embodiment includes a multimedia system. The multimedia system includes a monitor for displaying multimedia content, a microphone for capturing user sounds, and a computer connected to the microphone and the monitor. The computer drives the monitor and receives a voice input from the microphone. The computer determines whether the voice input is for a novice mode or an experienced mode of speech recognition. The computer displays a voice user interface on the monitor in response to determining that the voice input is for the novice mode; the voice user interface shows one or more speech commands that are available. The computer provides speech recognition training feedback through the voice user interface when in the novice mode. The computer recognizes a speech recognition command in the voice input if the voice input is for the experienced mode; the speech recognition command is not presented in the voice user interface at the time of the voice input. The computer controls the multimedia system based on the speech recognition command in the voice input in response to recognizing the speech recognition command in the voice input.

One embodiment includes a processor readable storage device having instructions stored thereon for programming one or more processors to perform a method for controlling a multimedia system. The method comprises receiving a voice input when in a mode in which speech recognition is not currently being used to control the multimedia system. The method also includes recognizing a trigger voice signal in the voice input, and determining whether the trigger voice signal is followed by a presently valid speech command. A speech recognition user interface is displayed on a display screen of the multimedia system in response to determining that the trigger voice signal is not followed by any presently valid speech commands. The speech recognition user interface shows one or more speech commands that are presently available to control the multimedia system. The one or more speech commands include the presently valid speech command. Speech recognition training feedback is presented through the speech recognition user interface. The multimedia system is controlled based on the presently valid speech command if it is determined that the trigger voice signal is followed by the presently valid speech command. Controlling the multimedia system if the trigger voice signal is followed by the presently valid speech command is performed without displaying the speech recognition user interface on the display screen. In some embodiments, active or passive confirmation as a condition of executing the speech command.

This Summary is provided to introduce a selection of concepts in a simplified form that are further described below in the Detailed Description. A further understanding of the nature and advantages of the device and methods disclosed herein may be realized by reference to the complete specification and the drawings. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a user in an example multimedia environment having a capture device for capturing and tracking user body positions and movements and receiving user sound commands.

FIG. 2 is a block diagram illustrating one embodiment of a capture device coupled to a computing device.

FIG. 3 is a flowchart illustrating one embodiment of a process for recognizing speech.

FIGS. 4A, 4B, 4C, and 4D are diagrams illustrating various voice user interfaces in accordance with embodiments.

FIG. 5 is a flowchart illustrating one embodiment of a process of determining whether to enter a novice mode or an experienced mode of speech recognition.

FIG. 6 is a flowchart illustrating one embodiment of a process of providing speech recognition training to the user while in novice mode.

FIG. 7 is a flowchart illustrating another embodiment of a process of providing speech recognition feedback to the user while in novice mode.

FIG. 8 depicts a flowchart of one embodiment of a process of determining whether to seek confirmation for performing a speech command.

FIGS. 9A and 9B are diagrams illustrating voice user interfaces that may be used when seeking confirmation from a user for performing a speech command.

FIG. 10 is a flowchart depicting one embodiment of a process for automatically exiting the novice mode.

FIG. 11 is a flow chart describing the process for recognizing speech commands.

FIG. 12 is a block diagram illustrating one embodiment of a computing system for processing data received from a capture device.

FIG. 13 is a block diagram illustrating another embodiment of a computing system for processing data received from a capture device.

### DETAILED DESCRIPTION

Speech recognition techniques are disclosed herein. In one embodiment, a novice mode is available such that when the user is unfamiliar with the speech recognition system, a voice user interface (VUI) may be provided to guide them. The VUI may display one or more speech commands that are presently available. The VUI may also provide feedback to train the user. After the user becomes more familiar with speech recognition, the user may enter speech commands without the aid of the novice mode. In this “experienced mode,” the VUI need not be displayed. Therefore, the overall product user interface is not cluttered. A given user could switch between the novice mode and experienced mode based on factors such as their familiarity with the speech commands presently available. For example, the user might be familiar with speech commands used to control one application, but not with the speech commands used to control another application. The system may automatically determine which mode to enter based on a trigger voice signal. For example, if the user speaks a trigger signal followed by a presently valid speech command, the system may automatically go into the experienced mode. On the other hand, if the user speaks the trigger signal without following up with a presently valid speech command within a pre-determined time, the system may automatically go into the novice mode.

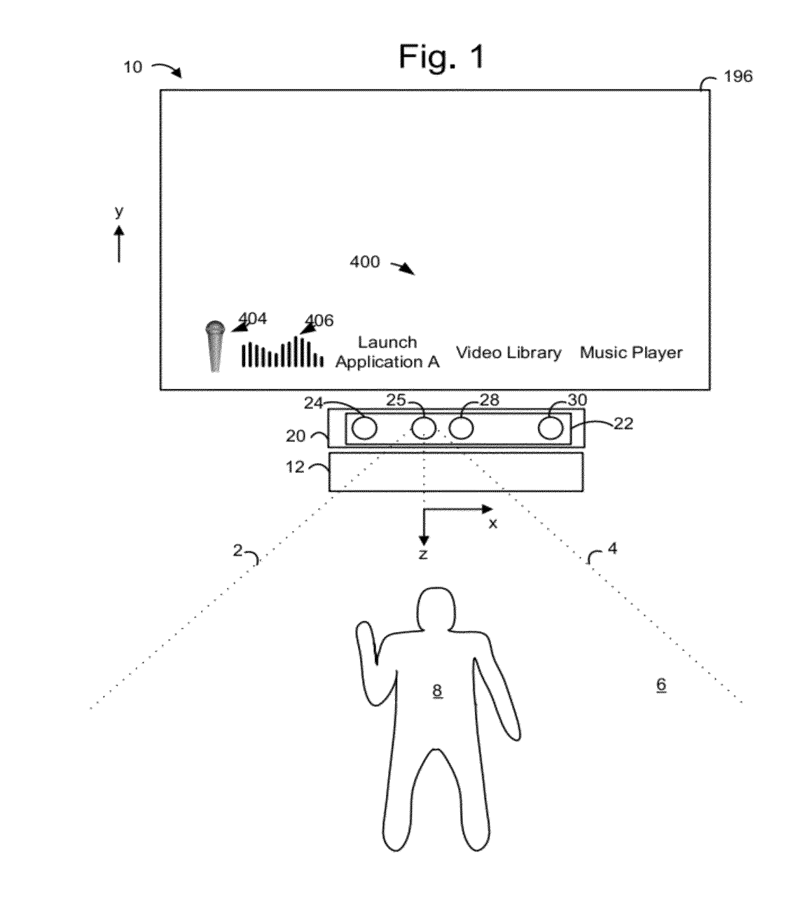

Speech recognition technology disclosed herein may be used with any electronic device. For purpose of illustration, an example in which the electronic device is a multimedia entertainment system will be presented. It will be understood that the technology disclosed is not limited to the example multimedia entertainment system. FIG. 1 illustrates a user 18 interacting with a multimedia entertainment system 10 in a boxing video game. The system 10 is configured to capture, analyze and track movements and sounds made by the user 18 within range of a capture device 20 of system 10. This allows the user to interact with the system 10 using speech commands or gestures, as further described below.

FIG. 1 depicts an example of a motion capture system 10 in which a person interacts with an application. The motion capture system 10 includes a display 196, a depth camera system 20, and a computing environment or apparatus 12. Further, the capture device 20 may include one or more microphones 30 to detect speech commands and other sounds issued by the user 18. In one embodiment, the computing system 12 includes hardware components and/or software components such that computing system 12 is used to execute applications, such as gaming applications or other applications. In one embodiment, computing system 12 includes a processor such as a standardized processor, a specialized processor, a microprocessor, or the like, that executes instructions stored on a processor readable storage device for performing the processes described below. For example, the movements and sounds captured by capture device 20 are sent to the controller 12 for processing, where recognition software will analyze the movements and sounds to determine their meaning within the context of the application.

The system 10 is able to recognize speech commands from user 8. In one embodiment, the user 8 may use speech commands to end, pause, or save a game, select a level, view high scores, communicate with a friend, and so forth. The user may use speech commands to select the game or other application from a main user interface, or to otherwise navigate a menu of options. The motion capture system 10 may further be used to interpret speech commands as operating system and/or application controls that are outside the realm of games and other applications which are meant for entertainment and leisure. For example, virtually any controllable aspect of an operating system and/or application may be controlled by speech commands.

A voice user interface (VUI) 400 on the display 196 is used to train the user 8 on how to use speech recognition commands. The VUI 400 in this example shows a number of commands (e.g., launch application, video library, music player) that are presently available. The VUI 400 is typically displayed when the user 8 might need assistance with speech recognition. However, after the user 8 becomes experienced with speech recognition the VUI 400 need not be displayed. Therefore, the VUI 400 does not interfere with other parts of the system's user interface. Further details of the VUI 400 are discussed below.

The depth camera system 20 may include an image camera component 22 having a light transmitter 24, light receiver 25, and a red-green-blue (RGB) camera 28. In one embodiment, the light transmitter 24 emits a collimated light beam. Examples of collimated light include, but are not limited to, Infrared (IR) and laser. In one embodiment, the light transmitter 24 is an LED. Light that reflects off from an object 8 in the field of view is detected by the light receiver 25.

A user 8, also referred to as a person or player, stands in a field of view 6 of the depth camera system 20. Lines 2 and 4 denote a boundary of the field of view 6. Generally, the motion capture system 10 is used to recognize, analyze, and/or track an object. The computing environment 12 can include a computer, a gaming system or console, or the like, as well as hardware components and/or software components to execute applications.

The depth camera system 20 may include a camera which is used to visually monitor one or more objects 8, such as the user, such that gestures and/or movements performed by the user may be captured, analyzed, and tracked to perform one or more controls or actions within an application, such as animating an avatar or on-screen character or selecting a menu item in a user interface (UI). In some embodiments, a combination of voice commands and user actions are used for control purposes. For example, a user might point to an object on the display 196 and say “play ‘object’”, where “object” may be the name of the object.

The motion capture system 10 may be connected to an audiovisual device such as the display 196, e.g., a television, a monitor, a high-definition television (HDTV), or the like, or even a projection on a wall or other surface, that provides a visual and audio output to the user. An audio output can also be provided via a separate device. To drive the display, the computing environment 12 may include a video adapter such as a graphics card and/or an audio adapter such as a sound card that provides audiovisual signals associated with an application. The display 196 may be connected to the computing environment 12 via, for example, an S-Video cable, a coaxial cable, an HDMI cable, a DVI cable, a VGA cable, or the like.

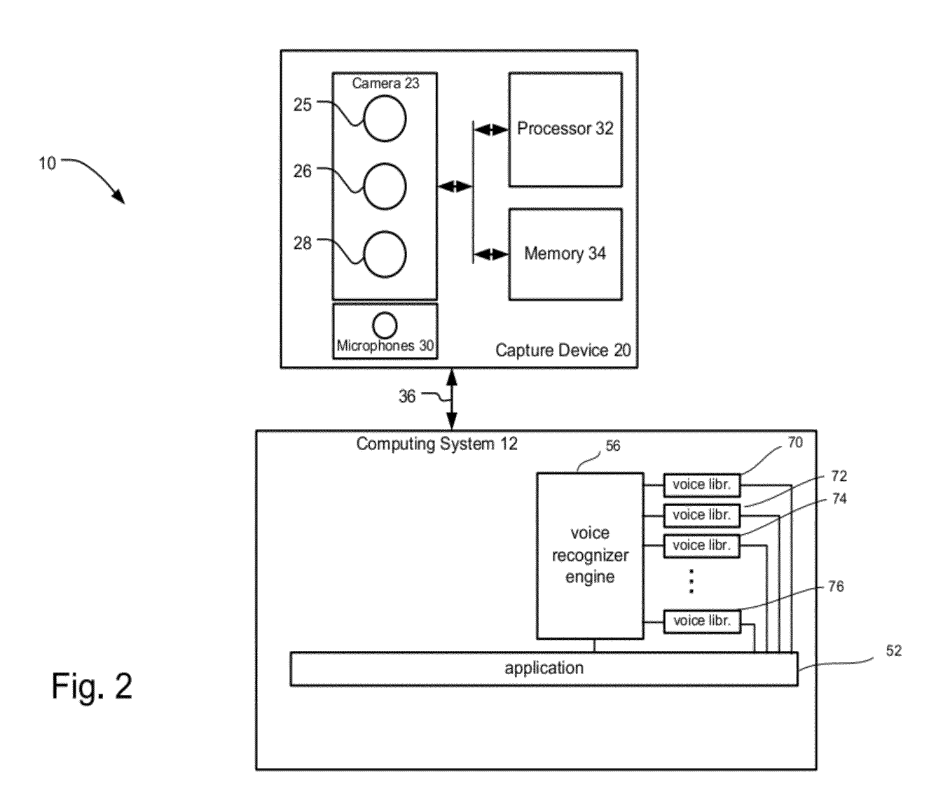

FIG. 2 illustrates one embodiment of the capture device 20 as coupled to computing device 12. The capture device 20 is configured to capture both audio and video information, such as poses or movements made by user 18, or sounds like speech commands issued by user 18. The captured video has depth information, including a depth image that may include depth values obtained with any suitable technique, including, for example, time-of-flight, structured light, stereo image, or other known methods. According to one embodiment, the capture device 20 may organize the depth information into “Z layers,” i.e., layers that are perpendicular to a Z axis extending from the depth camera along its line of sight.

The capture device 20 includes a camera component 23, such as a depth camera that captures a depth image of a scene. The depth image includes a two-dimensional (2D) pixel area of the captured scene, where each pixel in the 2D pixel area may represent a depth value, such as a distance in centimeters, millimeters, or the like, of an object in the captured scene from the camera.

As shown in the embodiment of FIG. 2, the camera component 23 includes an infrared (IR) light component 25, a three-dimensional (3D) camera 26, and an RGB (visual image) camera 28 that is used to capture the depth image of a scene. For example, in time-of-flight analysis, the IR light component 25 of the capture device 20 emits an infrared light onto the scene and then senses the backscattered light from the surface of one or more targets and objects in the scene using, for example, the 3D camera 26 and/or the RGB camera 28.

According to another embodiment, the capture device 20 may include two or more physically separated cameras that may view a scene from different angles to obtain visual stereo data that may be resolved to generate depth information. Other types of depth image sensors can also be used to create a depth image.

The capture device 20 further includes one or more microphones 30. As one example, there may be four microphones 30, although more or fewer could be used. Each of the microphones 30 includes a transducer or sensor that receives and converts sound into an electronic signal. According to one embodiment, the microphones 30 are used to reduce feedback between the capture device 20 and the controller 12 in system 10. According to one embodiment, background noise around the user 8 may be suppressed by suitable operation of the microphones 30. Additionally, the microphones 30 may be used to receive sounds including speech commands that are generated by the user 18 to select and control applications, including game and other applications that are executed by the controller 12. The capture device 20 also includes a memory component 34 that stores the instructions that are executed by processor 32, images or frames of images captured by the 3-D camera 26 and/or RGB camera 28, sound signals captured by microphones 30, or any other suitable information, images, sounds, or the like. According to one embodiment, the memory component 34 may include random access memory (RAM), read only memory (ROM), cache, flash memory, a hard disk, or any other suitable storage component. As shown in FIG. 2, in one embodiment, memory component 34 may be a separate component in communication with the image capture component 23 and the processor 32. According to another embodiment, the memory component 34 may be integrated into processor 32 and/or the image capture component 23.

As shown in FIG. 2, capture device 20 may be in communication with the controller or computing system 12 via a communication link 36. The communication link 36 may be a wired connection including, for example, a USB connection, an IEEE 1394 connection, an Ethernet cable connection, or the like and/or a wireless connection such as a wireless 802.11b, g, a, or n connection. According to one embodiment, the computing system 12 may provide a clock to the capture device 20 that may be used to determine when to capture, for example, a scene via the communication link 36. Additionally, the capture device 20 provides the depth information and visual (e.g., RGB) images captured by, for example, the 3-D camera 26 and/or the RGB camera 28 to the computing system 12 via the communication link 36. In one embodiment, the depth images and visual images are transmitted at 30 frames per second. The computing system 12 may then use the model, depth information, and captured images to, for example, control an application such as a game or word processor and/or animate an avatar or on-screen character.

Voice recognizer engine 56 is associated with a collection of voice libraries 70, 72, 74 . . . 76 each having information concerning speech commands that may be associated with different contexts. For example, the set of speech commands that may be available could vary from one application or context to another. As a specific example, commands such as “fast forward,” “play,” and “stop” might be suitable for one application or context, but not for another. The speech commands may be associated with various controls, objects or conditions of application 52.

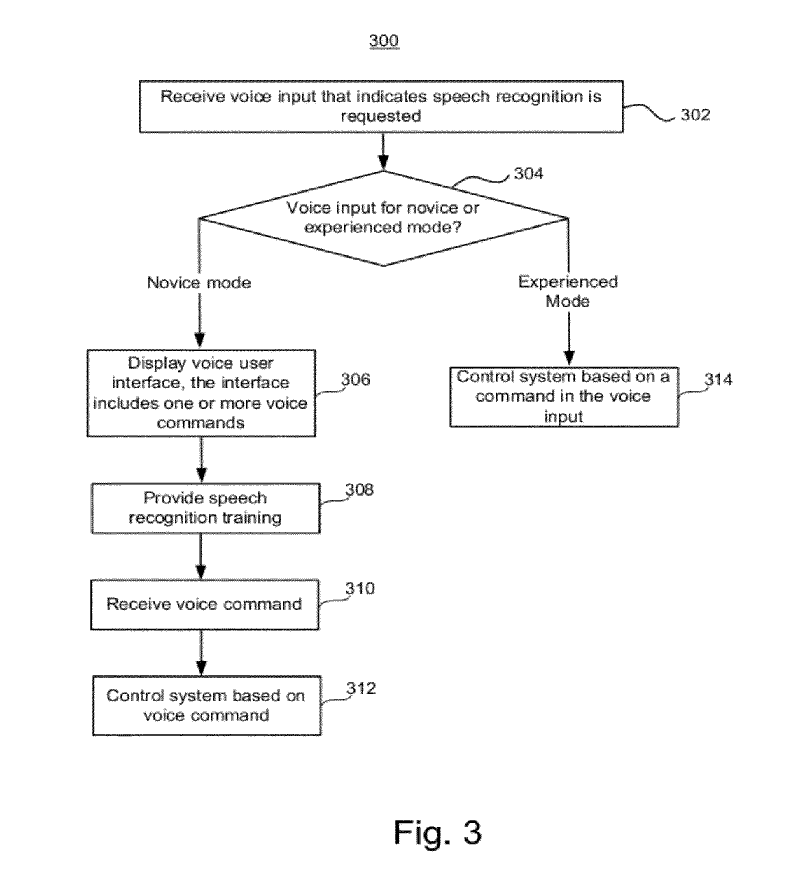

FIG. 3 is a flowchart illustrating one embodiment of a process 300 for recognizing speech. Process 300 may be implemented by a multimedia system 10, as one example. However, process 300 could be in another type of electronic device. For example, process 300 could be performed in an electronic device that has voice recognition, but does not have a depth detection camera.

Prior to step 302, the system may be in a mode in which speech recognition is not presently being used. The VUI is typically not displayed at this time. In step 302, voice input that indicates speech recognition is requested is received. In some embodiments, this voice input is a trigger voice signal, such as a certain word. The user may have been previously instructed what the trigger voice signal is. For example, there may be some documentation that goes with the system that explains that to invoke speech recognition that a certain word should be spoken. Alternatively, the user might be instructed during an initial setup. In one embodiment, the microphone 30 continuously receives voice input and provides it to voice recognition engine 28, which monitors for the trigger voice signal.

In step 304, a determination is made whether the voice input is for a first mode (e.g., novice mode) or a second mode (e.g., experienced mode) of speech recognition. In one embodiment, to initiate the novice mode, the user pauses after saying the trigger voice signal. To initiate the experienced mode, the user may speak a speech command within a timeout period following the trigger voice signal. Other techniques could be used to distinguish between the novice mode and experienced mode.

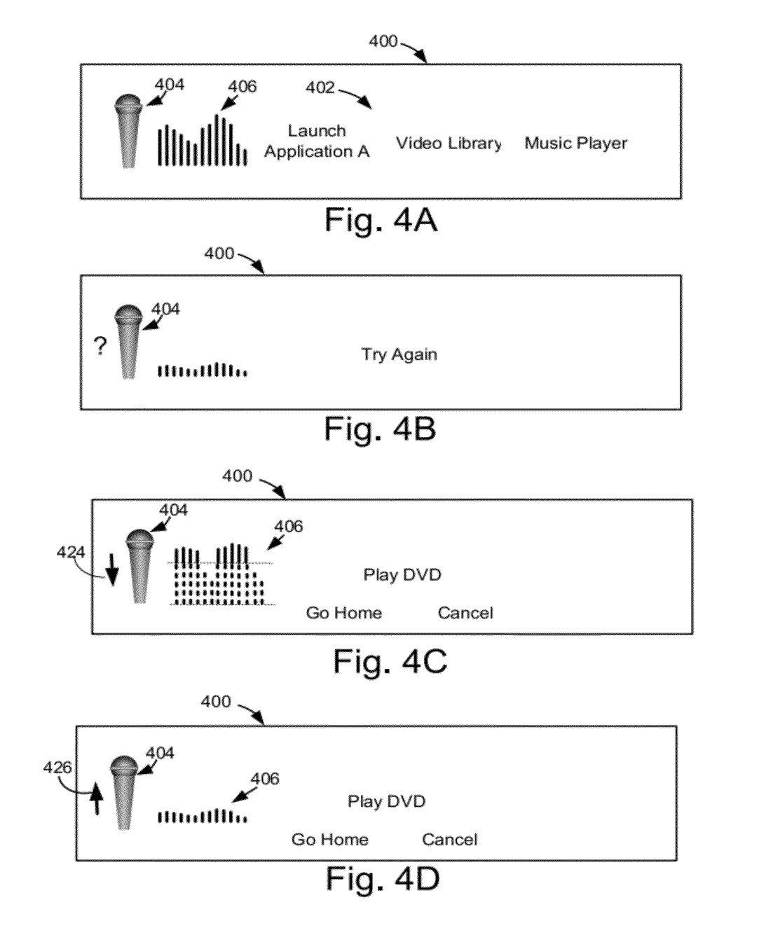

If the system determines that the voice input of step 302 is for the novice mode, then steps 306-312 are performed. In general, the novice mode may include presenting a VUI to the user to assist in training the user how to use speech recognition. In step 306, a VUI is displayed in a user interface. FIG. 4A depicts one embodiment of a VUI 400. The VUI displays one or more speech commands 402 that are presently available (or valid). In this example, the speech commands 402 pertain to accessing different applications or libraries. The VUI 400 cues the user that the presently available speech commands 402 include “Launch Application A,” which results in a particular software application (e.g., a video web site) being launched; “Video Library,” which results in a video library being accessed; and “Music Player,” which results in a music player being launched.

The example VUI 400 of FIG. 4A also displays a microphone 404, which indicates to the user that the system is presently in voice recognition mode (e.g., the system will allow the user to enter speech commands without the trigger signal). The user may be informed at some earlier time that the microphone symbol indicates the speech recognition mode is active. For example, there may be some documentation that goes with the system, or an initial setup that explains this. A different type of symbol could be used to indicate speech recognition. Also, the VUI 400 could even display word such as “speech recognition active,” or some other words. Note that the VUI 400 may be presented over another user interface; however, the other user interface is not shown so as to not obscure the diagrams.

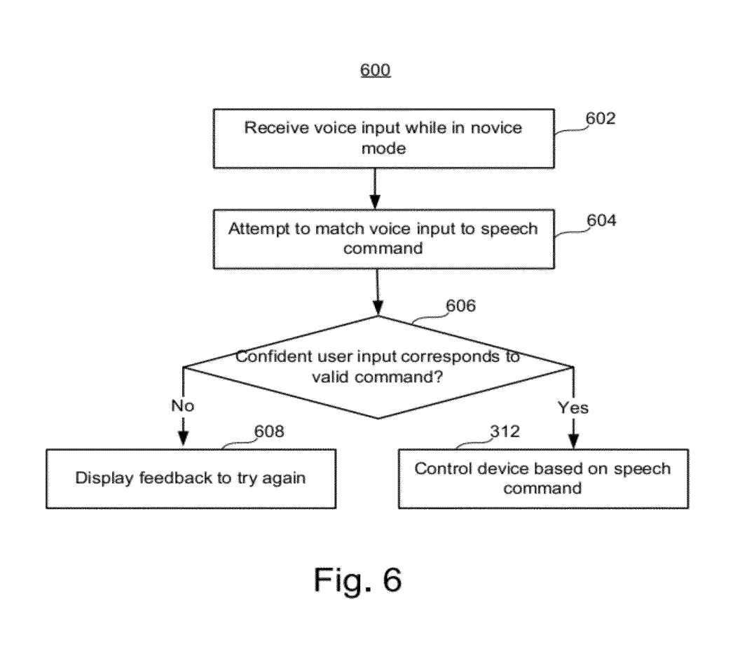

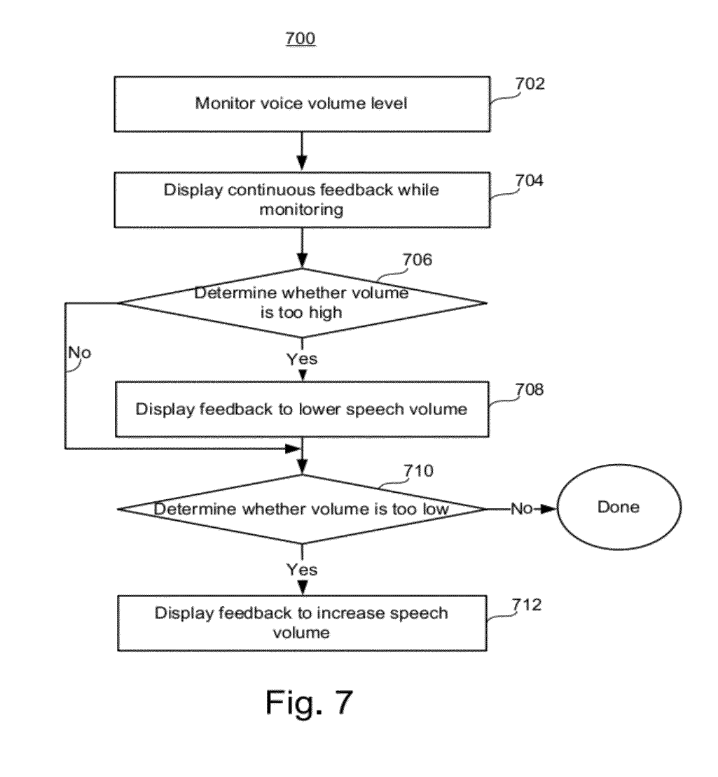

In step 308, the system provides speech recognition training (or feedback) to the user through the VUI 400. For example, the volume meter 406 provides feedback to the user as to the volume and speed of their speech. The example meter 406 has a number of bars whose height corresponds to a volume for a different frequency range; however, other types of meters could be used. The meter 406 may assist the user in determining whether they are speaking loudly enough. Since the system also inputs ambient noises, the user is able to determine whether ambient noises may be masking their voice input. The bars in the meter 406 move in response to the user's voice input, which may provide visual feedback as to the rate of user's speech. The feedback may allow the user to modify their voice input without significant interruption. The visual feedback may help the user to learn more quickly how to provide voice input for accurate speech recognition. Other embodiments of providing speech recognition training are discussed below in connection with FIGS. 6 and 7. Note that providing speech recognition training may take place at any time when in the novice mode.

In step 310, a speech command is received while in the novice mode. This voice input could be one of the speech commands 402 that are presently displayed in the VUI 400. For example, the user may say, “Music Player.” In some embodiments, the system determines whether the voice input that was received is a valid speech command. Further details of determining whether a speech command is valid are discussed below. Note that once the novice mode has been entered as a result of the trigger signal (step 302), the user is not required to re-enter the trigger signal to enter a voice command.

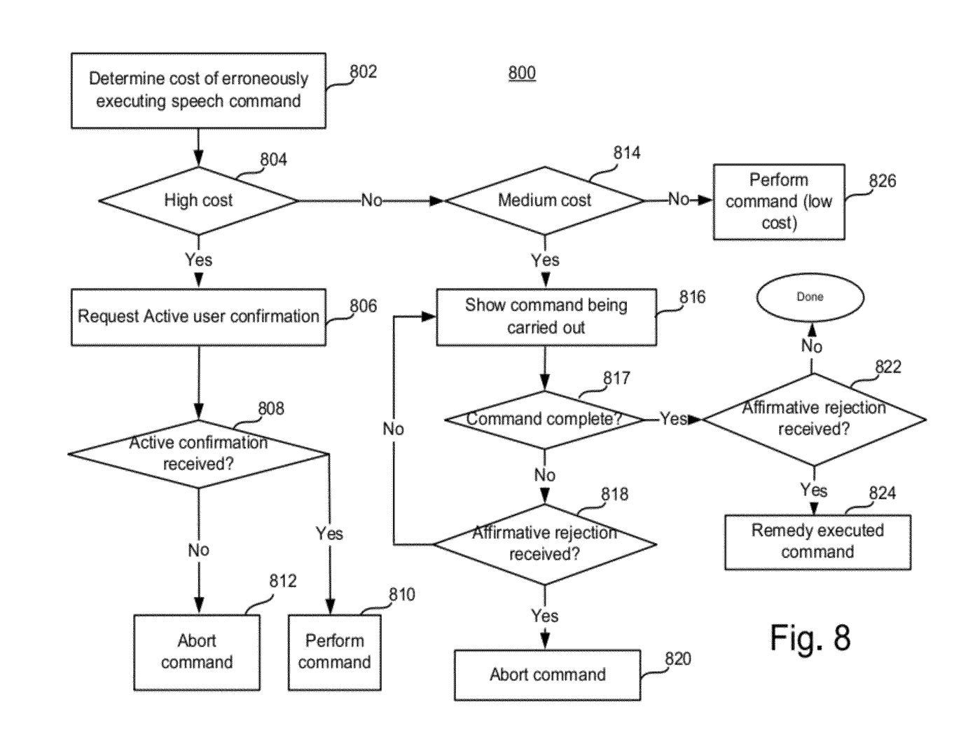

In step 312, the system controls the electronic device (e.g., controls the multimedia system) based on the speech command of step 310. In the present example, the system launches the music player. The VUI 400 may then change to update the available commands for the music player. In some embodiments, the system determines whether it should seek confirmation from the user whether to carry out the speech command. In one embodiment, the system determines a cost of performing an action erroneously and determines whether to seek active confirmation (user is requested to respond), passive confirmation (action is performed so long as user does not respond), or no confirmation based on the cost of a mistake. The cost may be defined in terms of the magnitude of negative impact on the user experience. Further details of seeking confirmation are discussed below in the process of FIG. 8.

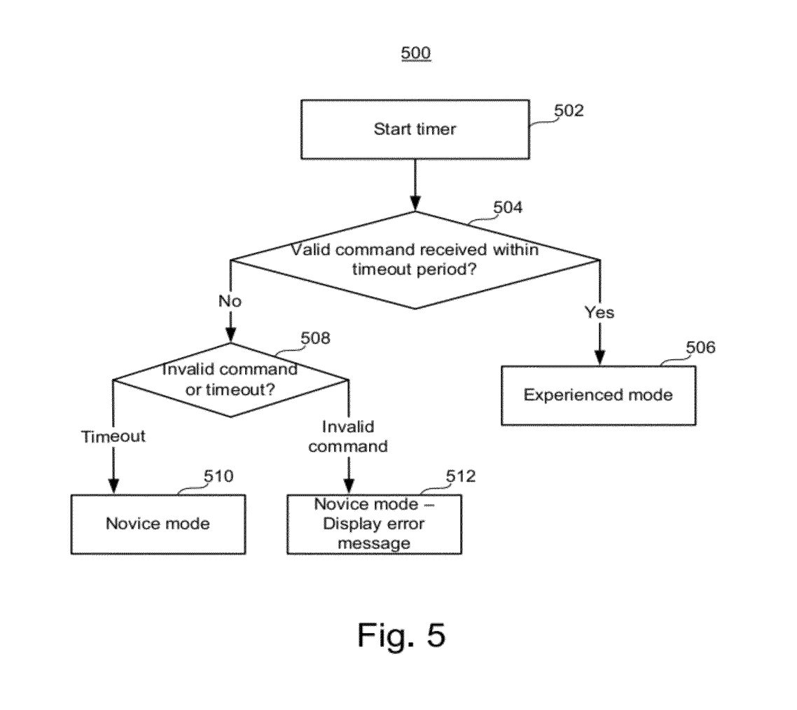

If the input received in step 302 is for the experienced mode, then step 314 is performed. In one embodiment, the system determines that the experienced mode should be entered by determining that a valid command (given the current context) is entered in step 302. Further details are discussed in connection with FIG. 5. In step 314, the system is controlled based on a speech command in the voice input of step 302 while in the experienced mode. Note that, according to embodiments, the VUI 400 is not displayed while in the experienced mode. The VUI may be used in certain situation in the experienced mode, such as to seek confirmation of whether to carry out a voice command. Therefore, the VUI does not clutter the display.

FIG. 5 is a flowchart illustrating one embodiment of a process 500 of determining whether to enter a novice mode or an experienced mode of speech recognition. Process 500 provides more details for one embodiment of step 304 of process 300. Process 500 begins after receiving the voice input that indicates that speech recognition is requested in step 302 of process 300. In one embodiment, the voice input that indicates that speech recognition is requested is a voice trigger signal. For example, the user might use the same voice trigger signal to establish both the novice mode and the experienced mode. Moreover, the same voice trigger signal could be used for different contexts. In step 502, a timer is started. The timer begins when the user completes entrance of the trigger signal and is set to expire at a pre-determined time later. The pre-determined time can be any period such as one second, a few seconds, etc.

In step 504, a determination is made whether a valid speech command is received prior to the timer expiring. If so, then the system enters the experienced mode in step 506. If not, then the action taken may depend on whether an invalid command was received or the timeout occurred prior to receiving any speech command (determined by step 508). In either case, the novice mode may be entered. FIG. 4A depicts an example VUI 400 that could be displayed for the case in which no invalid speech command was received (step 510). However, in the event that an invalid speech command was received, then an error message may be presented to the user (step 512). For example, if the user said the trigger signal followed by “play,” but play was not a valid command at that time, then the VUI 400 may be presented. Once the VUI 400 is displayed, the user might be informed that they had made an error. For example, referring to FIG. 4B, the message “try again” may be displayed in the VUI 400. Then, the VUI 400 of FIG. 4A might be displayed to show the user valid speech commands 402. Note that it is not required that the system display the error message (e.g., FIG. 4B) when first establishing the novice mode. Instead, the system might initiate the novice mode by presenting the VUI 400 of FIG. 4A.

In some embodiments, the system provides speech recognition training (or feedback) to the user while in the novice mode. This training may be presented through the VUI 400. The training may be presented at any time when in the novice mode. FIG. 6 is a flowchart illustrating one embodiment of a process 600 of providing voice recognition training to the user while in novice mode. Process 600 is one embodiment of step 308 of process 300. Note that step 308 is depicted in a particular location in process 300 as a matter of convenience. Step 308 may be ongoing throughout the novice mode.

In step 602, the system receives voice input while in novice mode. For the sake of example, this voice input is not the voice input of step 302 of process 300 that triggered the speech recognition. Rather, it is voice input that is provided after the VUI is initially displayed in step 308 of process 300.

In step 604, the system attempts to match voice input to a valid speech command. In one embodiment, at some point the system loads a set of one or more valid speech commands depending on the context (typically, prior to step 604). The system may select from among speech command sets (e.g., libraries 70, 72, 74, 76) that are valid for different contexts. For example, there might be a high level set of speech commands that allow the user to launch different applications. Once the user launches an application, the speech commands may include ones that are specific to that application. The valid speech commands may be loaded into the speech recognizer engine 56 such that the matching of step 604 may be performed. These valid speech commands may correspond to the commands presented in the VUI 400.

In step 606, the system determines whether the level of confidence of the voice input matching a valid speech command is sufficiently high. If so, the system performs an action for the speech command. If not, then the system displays feedback for the user to attempt another voice input in step 608. For example, referring to FIG. 4B, the VUI 400 displays “Try Again.” Also, the VUI 400 may show a question mark (“?”) next to the microphone 404. Either or both of these feedback mechanisms may cue the user that their voice input was not understood. Moreover, the feedback is presented in an unobtrusive manner.

FIG. 7 is a flowchart illustrating another embodiment of a process 700 of providing speech recognition feedback to the user while in novice mode. Process 700 is one embodiment of step 308 of process 300. Process 700 is concerned with the processing of voice input that is received at any time during the novice mode.

In step 702, the system monitors the volume level of the voice input. As the system is monitoring the volume, the system may display feedback continuously in step 704. For example, the system presents the volume meter 406 in the VUI 400. The system may also compare the voice input to one or more volume levels. For example, the system may determine whether the volume is too high and/or too low.

In step 706, the system determines whether the volume is too high. For example, the system determines whether the volume is greater than a pre-determined level. In response, the system displays feedback to the user in the VUI 400 in step 708. FIG. 4C depicts one example of a VUI 400 showing feedback that the volume is too high. In FIG. 4C, there is an arrow 424 pointing downward next to the microphone 404 to cue the user that they are speaking too loudly. The volume meter 406 also presents feedback to indicate that the user is speaking too loudly. In some embodiments, the tops of the lines in the volume meter 406 are displayed in a certain color to warn the user. For example, the tops may be displayed in red or yellow to warn the user. The lower portions of the lines may be presented in green to indicate that this level is acceptable.

In step 710, the system determines whether the volume is too low. For example, the system determines whether the volume is lower than a pre-determined level. In response, the system displays feedback in the VUI 400 to the user in step 712. FIG. 4D depicts one example of feedback that the volume is too low. In FIG. 4D, there is an arrow 426 pointing upward next to the microphone 404 to cue the user that they are speaking too softly. The volume meter 406 may also present feedback to indicate that the user is speaking too softly based on the height of the lines.

Note that the feedback may be based on many different factors. For example, the volume meter 406 may indicate the amount of ambient noise. Therefore, the user is able to compare how the volume of their speech compares to the ambient noise, and adjust their speech accordingly. Also, the height of the lines in the volume meter 406 may be updated at some suitable frequency (e.g., many times per second) such that the user is provided feedback as to the speed of their speech. Over time the user may learn that speaking too rapidly leads to poor speech recognition by the system.

In some embodiments, the system seeks confirmation from the user prior to performing a speech command. Thus, after determining that a valid speech command has been received, the system may seek active or passive confirmation prior to executing the command. Seeking active or passive confirmation may be performed when in either the novice mode or the experienced mode. FIG. 8 depicts a flowchart of one embodiment of a process 800 of determining whether to seek confirmation for performing a speech command, and if so, seeking active or passive confirmation. In one embodiment, process 800 is performed prior to step 312 of FIG. 3.

In step 802, the system determines a cost of erroneously performing a speech command. In one embodiment, the system determines whether there would be a high-medium-, or low-cost. The cost can be measured based on the inconvenience to the user of remedying an erroneously performed speech command. The cost may also be based on whether the error can be remedied at all. For example, a transaction to purchase an item could have a high cost if erroneously performed. Likewise, an operation to delete a file might have a high cost if erroneously performed. For example, if the user is watching a movie, a speech command to exit the application could be considered high cost because of the inconvenience to the user of having to restart the movie. It also might be deemed a medium cost. The determination of which commands are high-cost, which are medium-cost, and which are low-cost may be a design choice. Note that there could be more or fewer than three categories (high, medium, low).

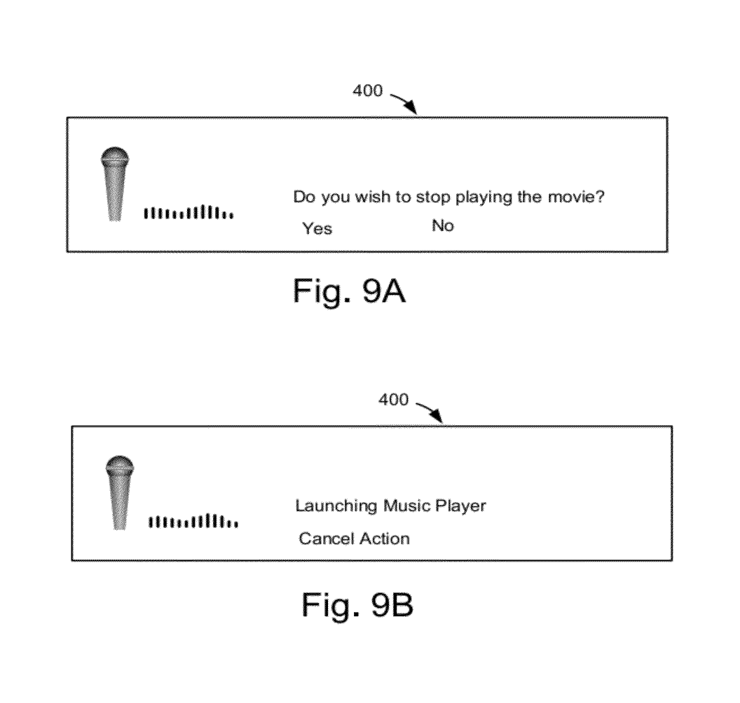

In step 804, the system determines that the cost of erroneously executing the speech command is high. Therefore, in step 806, the system requests active confirmation from the user to proceed with the command. FIG. 9A depicts an example in which the VUI 400 asks for active confirmation from the user by the request, “do you wish to stop playing the movie.” The VUI 400 also displays the speech commands “Yes” and “No” to cue the user as to how to respond. Other speech commands might be used.

If the user provides active confirmation (as determined by step 808), then the speech command is performed in step 810. If the user does not provide active confirmation (step 808), then the speech command is aborted in step 812. The system may continue to present the VUI 400 with presently available speech commands. However, instead the system may discontinue showing the VUI 400.

In step 814, the system determines that the cost of erroneously performing the speech command is medium. If the system determines that the cost of erroneously performing the speech command is medium, then the system may seek passive confirmation from the user. An example of passive confirmation is to perform the speech command so long as the user does not attempt to stop the speech command from executing for some period of time.

In step 816, the system displays a message that the speech command is about to (or is already) being performed. For example, referring to FIG. 9B, the VUI 400 has the message, “Launching Music Player.” Note that this message might be displayed slightly before launch to give the user time to react, but that is not required. The VUI 400 of FIG. 9B also shows the speech command “Cancel Action,” which cues the user how to stop the launch.

The system may determine whether the command has finished executing (step 817). So long as the command is still executing, the system may determine whether the user has affirmatively requested whether the command should be aborted (step 818). Provided that the user does not attempt to cancel the action, the system continues with executing the speech command return to step 816). However, if the user does attempt to stop this command from executing (step 818), then the system may abort the command, in step 820. Note that the request from the user to cancel the action could be received prior to completion of the speech command or even after the speech command has been fully executed. Therefore, if the command completes prior to receiving affirmative rejection from the user (step 817 is “yes”), then the system could still respond to an affirmative rejection from the user (step 822). Step 824 could include the system taking some action to remedy the situation after the command has fully executed. For example, the system could simply close the music player application after the command to open the music player has been carried out. If the user does not provide affirmative rejection of the command within some period after the command has completed, the process ends.

In step 826, the system determines that the cost of erroneously performing the speech command is low. If the system determines that the cost of erroneously performing the speech command is low, then the system may perform the speech command without seeking any active or passive conformation from the user, in step 822.

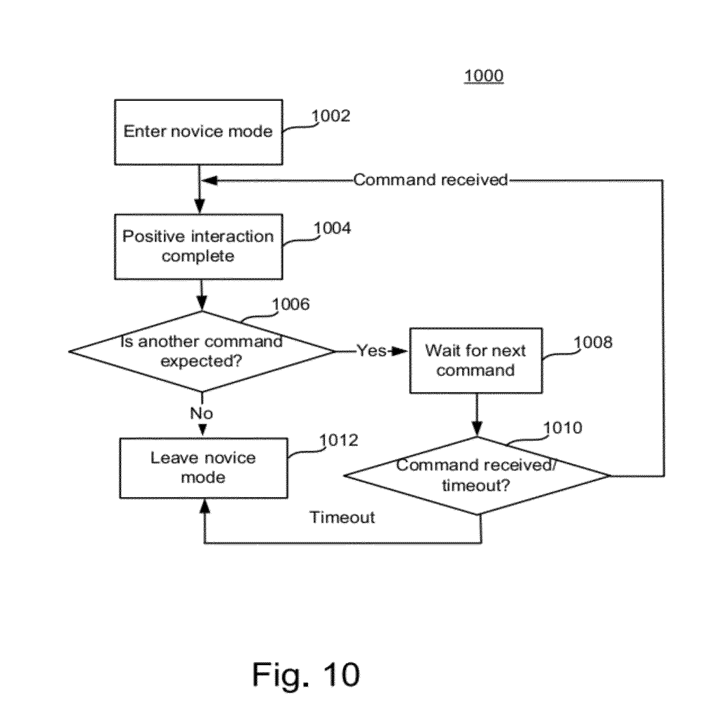

As noted herein, the VUI 400 may be displayed when useful to assist the user with speech recognition input. However, if the VUI 400 were to be continuously displayed, it might be intrusive to the user. In some embodiments, the system automatically determines that the VUI 400 should no longer be displayed for reasons including, but not limited to, the user is not presently using the VUI 400. FIG. 10 is a flowchart depicting one embodiment of a process 1000 for automatically exiting the novice mode, such that the VUI 400 is no longer displayed.

In step 1002, the system enters the novice mode in which the VUI 400 is displayed. As previously noted, the VUI 400 may be displayed over another user interface. For example, the system may have a main user interface over which the VUI 400 is presented. Note that the main user interface may be different depending on the context. For example, the main user interface may have different screen types and layouts depending on the context. As an overlay, the VUI 400 may integrate seamlessly with the main user interface without compromising the main user interface. Note that designers may be able to make changes to the main user interface without impacting the VUI and vice versa. Therefore, the main user interface and VUI are able to evolve separately.

In step 1004, the system determines that a speech recognition interaction has successfully completed. In step 1006, the system determines whether another speech recognition command is expected. For example, certain commands might be expected to be followed by others. One example is that after a “fast forward” command, the system might expect a “stop” or “play” command. Therefore, the system may stay in the novice mode to continue to assist the user by waiting for the next command in step 1008. If another command is received (step 1010), the process 1000 may return to step 1006 to determine whether another command is expected. As one option, if the next command is not received within a timeout period, the system could automatically exit the novice mode (step 1012). However, this option is not required. Note that while in the novice mode, the user is not required to re-enter the trigger signal.

If another command is not expected (step 1006), then the novice mode may be exited automatically by the system, in step 1012. Thus, the system may remove the VUI 400 from the display automatically. Consequently, the user experience may be improved because the user does not need to take any active steps to remove the VUI 400.

Process 1000 describes one embodiment of leaving the novice mode; however, other embodiments are possible. In one embodiment, the user may enter a voice input such as “cancel voice mode” to exit the novice mode. The system could respond to such an input at any time that the novice mode is in operation. Also note that variations of process 1000 are possible. Process 1000 indicated that one option is to exit the novice mode automatically upon expiration of a timeout (step 1010). The timeout option could be used in other contexts. For example, even if another command is not expected (step 1006), the system could wait for a timeout prior to leaving the novice mode.

In some embodiments, the VUI 400 has a first region in which local voice commands are presented and a second region in which global voice commands are presented. A local command may be one that is applicable to the present context, but is not necessarily applicable to other contexts. A global command is one that typically is applicable to a wider range of contexts, up to all contexts. For example, referring to FIGS. 4C and 4D, the local command “Play DVD” is presented in one region, and the global commands “Go Home” and “Cancel” are presented in a second region. In some cases, the user might be more familiar with the global voice commands, as they might be used again and again in different contexts. In other cases, the user might be more familiar with the local voice commands, such as if the user has substantial experience using voice commands with a particular application. Regardless, by separating the local and global voice commands the user may more quickly find the voice commands of interest to them.

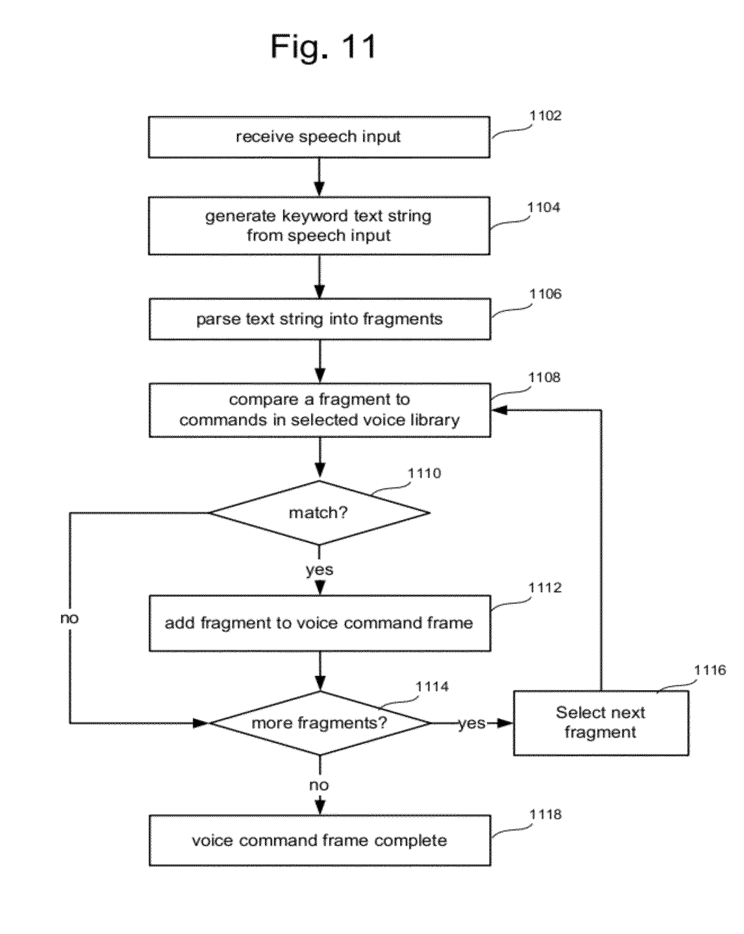

FIG. 11 is a flow chart describing the process for recognizing speech commands. The process depicted in FIG. 11 is one example implementation of step 604 of FIG. 6. In step 1102 the controller 12 receives speech input captured from microphone 30 and initiates processing of the captured speech input. Step 1102 is one embodiment of either step 302 or step 310 from process 300.

In step 1104, the controller 12 generates a keyword text string from the speech input, then in step 1106, the text string is parsed into fragments. In step 1108, each fragment is compared to relevant commands in one or more of the voice libraries 70, 72, 74, 76. If there is a match between the fragment and the voice library in step 1110, then the fragment is added to a speech command frame in step 1112, and the process checks for more fragments in step 1114. If there was no match in step 490, then the process simply jumps to step 1114 to check for more fragments. If there are more fragments, the next fragment is selected in step 1116 and compared to the voice library in step 1108. When there are no more fragments at step 494, the speech command frame is complete (step 1118), and the speech command has been identified.

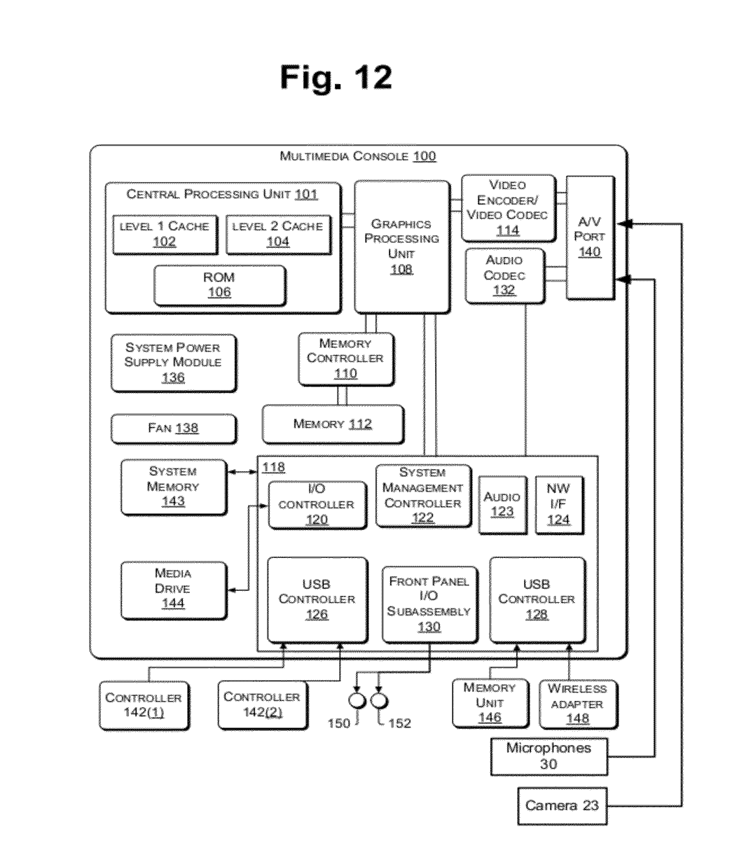

FIG. 12 illustrates one embodiment of the controller 12 shown in FIG. 1 implemented as a multimedia console 100, such as a gaming console. The multimedia console 100 has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered on.

One or more microphones 30 may provide input to the console 100 through A/V port 140. A camera 23 may also be input to A/V port 140. In one embodiment, the microphone 30 and camera are part of the same device and have a single connection to the console 100.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, Blu-Ray drive, hard disk drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio user or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered on, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., pop ups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications may be scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches. For example, the cameras 26, 28 and capture device 20 may define additional input devices for the console 100 via USB controller 126 or other interface.

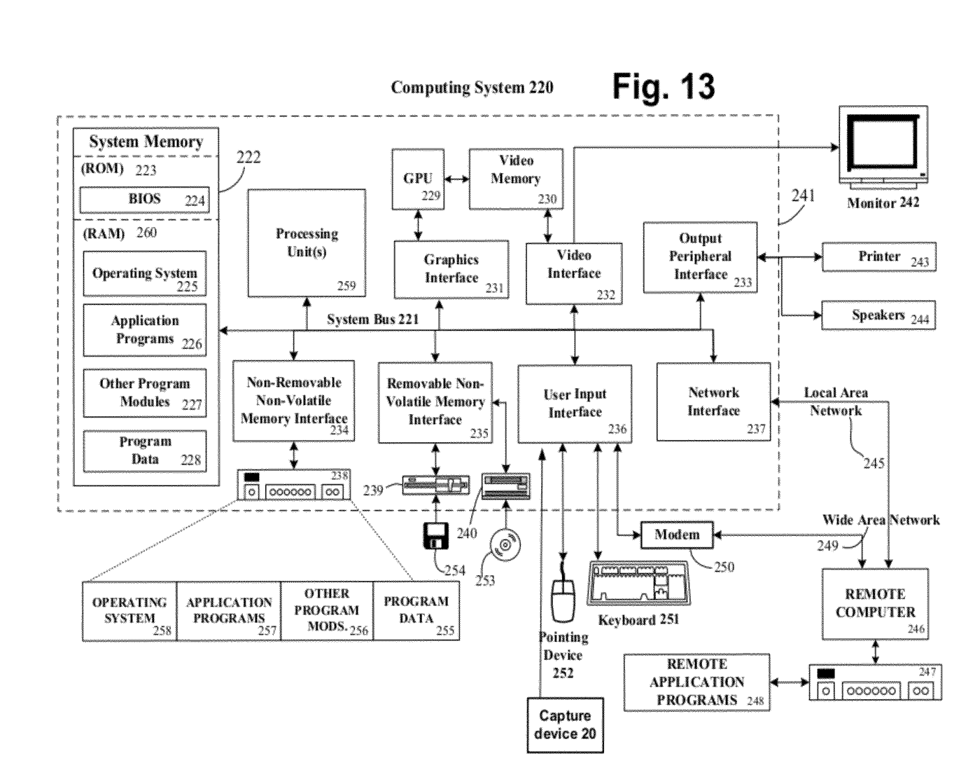

FIG. 13 illustrates another example embodiment of controller 12 implemented as a computing system 220. The computing system environment 220 is only one example of a suitable computing system and is not intended to suggest any limitation as to the scope of use or functionality of the presently disclosed subject matter. Neither should the computing system 220 be interpreted as having any dependency or requirement relating to any one or combination of components illustrated in the exemplary operating system 220. In some embodiments, the various depicted computing elements may include circuitry configured to instantiate specific aspects of the present disclosure. For example, the term circuitry used in the disclosure can include specialized hardware components configured to perform function(s) by firmware or switches. In other example embodiments, the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

Computing system 220 comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 13 illustrates operating system 225, application programs 226, other program modules 227, and program data 228 as being currently resident in RAM.

The computer 241 may also include other removable/non-removable, volatile/nonvolatile computer storage media. By way of example only, FIG. 5 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 13, provide storage of computer readable instructions, data structures, program modules and other data for the computer 241. In FIG. 13, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). For example, capture device 20, including cameras 26, 28 and microphones 30, may define additional input devices that connect via user input interface 236. A monitor 242 or other type of display device is also connected to the system bus 221 via an interface, such as a video interface 232. In addition to the monitor, computers may also include other peripheral output devices, such as speakers 244 and printer 243, which may be connected through an output peripheral interface 233. Capture Device 20 may connect to computing system 220 via output peripheral interface 233, network interface 237, or other interface.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 5. The logical connections depicted include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 13 illustrates application programs 248 as residing on memory device 247. It will be appreciated that the network connections shown are exemplary and other means of establishing a communications link between the computers may be used.

Either of the systems of FIG. 12 or 13, or a different computing system, can be used to implement controller 12 shown in FIGS. 1-2. As explained above, controller 12 captures sounds of the users, and recognizes these inputs as sound commands, and employs those recognized sound commands to control a video game or other application. In some embodiments, the system can simultaneously track multiple users and allow the motion and sounds of multiple users to control the application.

In general, those skilled in the art to which this disclosure relates will recognize that the specific features or acts described above are illustrative and not limiting. Rather, the specific features and acts described above are disclosed as example forms of implementing the claims. Accordingly, the scope of the invention is defined by the claims appended hereto.

We claim:

1. A method of controlling an electronic device, comprising:
receiving a voice input that indicates speech recognition is requested;
determining whether the voice input is for a first mode or a second mode of speech recognition;
displaying a voice user interface on a display screen of the electronic device in response to determining that the voice input is for the first mode, the voice user interface shows one or more speech commands that are currently available;
providing speech recognition training through the voice user interface when in the first mode; and
controlling the electronic device based on a command in the voice input in response to determining that the voice input is for the second mode.

2. The method of claim 1, wherein the determining whether the voice input is for a first mode or a second mode of speech recognition includes:
recognizing a presently valid command in the voice input; and
determining that the voice input is for the second mode in response to recognizing the presently valid command.

3. The method of claim 1, wherein the providing speech recognition training through the voice user interface includes providing visual feedback while the user is speaking.

4. The method of claim 1, further comprising:
automatically determining that a user is done using speech recognition, the automatically determining is performed while in the first mode; and
removing the voice user interface from the display in response to the automatically determining.

5. The method of claim 1, wherein the voice input for the first mode includes a trigger word followed by a pause of a pre-determined length.

6. The method of claim 5, wherein the voice input for the second mode includes the trigger word followed by the command.

7. The method of claim 1, wherein the voice user interface includes a first region for global commands and a second region for local commands that are specific to an application being presently controlled by the voice input.

8. The method of claim 1, wherein the voice user interface is overlaid on a graphical user interface.

9. The method of claim 1, further comprising receiving a voice command while in the first mode.

10. A multimedia system, comprising:
a monitor for displaying multimedia content;
a microphone for capturing user sounds; and
a computer connected to the microphone and the monitor, the computer driving the monitor, the computer receives a voice input from the microphone; the computer determines whether the voice input is for a novice mode or an experienced mode of speech recognition; the computer displays a voice user interface on the monitor in response to determining that the voice input is for the novice mode, the voice user interface shows one or more speech commands that are available; the computer provides speech recognition training feedback through the voice user interface when in the novice mode; the computer recognizes a speech recognition command in the voice input if the voice input is for the experienced mode, the speech recognition command is not presented in the voice user interface at the time of the voice input; and the computer controls the multimedia system based on the speech recognition command in the voice input in response to recognizing the speech recognition command in the voice input.

11. The multimedia system of claim 10, wherein the computer presents visual feedback in the voice user interface while the user is speaking as a part of providing the speech recognition training feedback.

12. The multimedia system of claim 10, wherein the computer:
automatically determines that a user is done using speech recognition, the automatically determining is performed while in the novice mode; and
remove the voice user interface from the display in response to the automatically determining.

13. The multimedia system of claim 10, wherein the computer recognizes a trigger word followed by a pause of a pre-determined length in the voice input as a condition of determining that the voice input is for the novice mode.

14. The multimedia system of claim 13, wherein the computer recognizes the trigger word followed by the command as a condition of determining that the voice input is for the experienced mode.

15. The multimedia system of claim 10, wherein the computer overlays the voice user interface on a graphical user interface.

16. A processor readable storage device having instructions stored thereon, the instructions for programming one or more processors to perform a method for controlling a multimedia system, the method comprising:
receiving a voice input when in a mode in which speech recognition is not currently being used to control the multimedia system;
recognizing a trigger voice signal in the voice input;
determining whether the trigger voice signal is followed by a presently valid speech command;
displaying a speech recognition user interface on a display screen of the multimedia system in response to determining that the trigger voice signal is not followed by any presently valid speech commands, the speech recognition user interface shows one or more speech commands that are presently available to control the multimedia system, the one or more speech commands include the presently valid speech command;
providing speech recognition training through the speech recognition user interface; and
controlling the multimedia system based on the presently valid speech command if it is determined that the trigger voice signal is followed by the presently valid speech command, the controlling the multimedia system if the trigger voice signal is followed by the presently valid speech command is performed without displaying the speech recognition user interface on the display screen.

17. The processor readable storage device of claim 16, wherein the providing speech recognition training through the speech recognition user interface includes providing real-time feedback based on audio input.

18. The processor readable storage device of claim 16, further comprising:
automatically determining that a user is done using speech recognition, the automatically determining is performed while displaying the speech recognition user interface; and
removing the speech recognition user interface from the display in response to the automatically determining.

19. The processor readable storage device of claim 16, wherein determining that the trigger voice signal is not followed by any presently valid speech commands includes determining that a pause of a pre-determined length follows the trigger voice signal.

20. The processor readable storage device of claim 19, further comprising:
receiving a first of the one or more presently valid speech commands;
determining a cost of acting on the first speech command, the cost includes low, medium, and high cost;
controlling the multimedia system in response to the first speech command without any confirmation from the user if the cost is low;
controlling the multimedia system in response to the first speech command with passive confirmation from the user if the cost is medium; and
controlling the multimedia system in response to the first speech command with active confirmation from the user if the cost is high.
